(19) United States
(12) Patent Application Publication
(10) Pub. No.: US 2016/0058230 A1
(43) Pub. Date: Mar. 3, 2016

(54) BAKING SYSTEM

(71) Applicant: NESTEC S.A., Vevey (CH)

(72) Inventors: Ted Choueiri, Lausanne (CH); Alexandre Perentes, Lausanne (CH)

(21) Appl. No.: 14/490,839

(22) Filed: Sep. 19, 2014

(30) Foreign Application Priority Data
Aug. 27, 2014 (EP) 14182367.4

(51) Int. Cl. A47J 27/00; B65D 25/20; B65D 81/34; A23L 1/01

(52) U.S. Cl. CPC A47J 27/004; A23L 1/0128; B65D 25/205; B65D 81/3453

(57) ABSTRACT

Packaged product comprising a food product to be cooked in a cooking device, the packaged product comprising identification means providing information to and readable by the cooking device related to a plurality of steps to be applied for cooking the food product according to a predetermined profile, such that, in particular the duration, the selection of the heating mode and the power level of each of the heating mode, optionally and additionally a cooling mode, are set for each one of these steps according to the type of product to be cooked. The heating mode for each step is selected amongst one or a combination of microwave heating, infrared heating, hot air convection or hot air impingement, the cooling mode being applied by one or a combination of sub-pressure cooling or air ventilation.

### REFERENCE TO RELATED APPLICATIONS

This application is based upon and claims the benefit of priority from the corresponding European Patent Application No. 14182367.4, filed on Aug. 27, 2014, the entire contents of which are incorporated herein by reference.

### FIELD

The present invention is directed to a system for preparing a plurality of dough-based products of premium quality in very short time. In particular, the invention is directed to an automated system for preparing a plurality of dough-based products in a dedicated cooking device, from a dedicated packaged product.

### BACKGROUND

Currently, in known baking devices, the user has to manually select the cooking profile such as heating element(s), cooking time, cooking steps, menu, etc., when cooking a product. Even the intelligent systems, i.e., systems having preprogrammed cooking profiles, must be manually parameterised by the user. Most users do not use or parameterize their baking systems correctly, or do not know how to do so, resulting in errors and loss of quality in the cooked goods. It would be therefore very advantageous to automate the whole process, so that the user's input would be minimized, resulting in optimized processes and higher quality products.

In standard cooking systems such as ovens, microwave ovens or combination ovens, the user has to determine the best heating profile and enter it manually: sometimes, the user may follow instructions printed on the products' packaging. The drawback of these systems is that the user has to continually monitor the quality of the product being cooked, and most of the time the product results being either under cooked or over cooked. Moreover, the instructions appearing on the packaging are made for a standard old cooking apparatus, and do not take into account the exact make and model of the cooking apparatus of the user, so the quality of the baking and of the baked good is at the most acceptable. In summary, there is usually a mismatch between the instruction on the package and the oven technology available.

There are known at present cooking systems having certain pre-programmed cooking profiles: these systems have a limited number of pre-programmed cooking profiles adapted to certain products. The user has to select the cooking profile, enter some parameters (usually the weight of the products to be cooked), put the product in the cavity, and launch the cooking. These systems (usually combination ovens) are pre-programmed for very generic product categories (fish, chicken, potatoes, etc . . . ) and are not adapted to specific products, so the user still has to monitor the baking, and while the results are usually better than with a fully manual system, the product at the end is still very often under cooked or over cooked or not cooked to the right external and/or internal desired texture (e.g., soft in the middle and crusty on the outer). Moreover, even when the users know how to use these systems correctly they often fail to do so after some time as they are not convenient enough.

Documents such as EP 1742513 and EP 1732358 are also known in the state of the art, disclosing a cooking apparatus used in such a way that the user has to scan a barcode on the product packaging to automatically set the cooking instructions such as power level, cooking time, etc. in the cooking apparatus. The barcode reader is located outside, in the front of the cooking apparatus. The drawback of these known systems is that they are not designed for working with dedicated products, so the result in the cooked products is very poor still. Besides, these systems use standard barcodes having one dimension, providing very limited information to the cooking apparatus.

All these existing systems are too imprecise to correctly cook or bake dough-based products such as bakery or pastry products. Certain products such as bread, croissants, with/without fillings, etc., are delicate and require a precise and specific baking profile adapted to the exact type of product (type of bread, type of pastry, etc.) in order to provide optimum end product results.

It would therefore be very advantageous to develop a baking system, in particular for dough-based products, which works in a complete automatic way and which adapts the baking profile as it is best for the product to be cooked. The present invention is oriented towards these needs.

Moreover, the heating technologies used in known baking systems do not provide an optimal end product: either the product is too dry or, if it is soft, it has not a good browning or an attractive crust.

For example, document US 2002/0071894 provides a cooking apparatus using microwaves for core heating and infrared radiation for surface heating: however, the final product is not homogeneous and the resulting product has an uneven browning; for this reason, US 2002/0071894 needs to provide a combination of movements of the product inside the cooking apparatus in order to improve such homogenization, which then results in a complicated, long and costly process. Also, the cooking apparatus is limited to initial products which have high relative humidity content, between 45% and 55% in volume: otherwise, the resulting product would be very dry and not satisfactory. Even more, infrared radiation is only efficiently applied to relatively flat and homogeneous products. Also, when using infrared radiation, there is a high heat transfer to the surroundings, such as for example, metal, electronics, etc. which makes the choice of components to be used for the cooking apparatus limited and more costly. Furthermore, the choice of packaging materials to reduce heat transfer is also very limited and much more costly than standard ones.

It is also known in the state of the art, as per PCT/US91/05470, for example, a cooking apparatus using microwaves for core heating of the product, and radiant heating (typically, infrared heating) for achieving a surface crust. However, the end product is again not homogeneous, and the apparatus is not automatic neither uses a proper baking profile for the product to be cooked, so the resulting product is not satisfactory. Again, the choice of components for the cooking apparatus and for the packaging of the product is much more limited and more costly.

The present invention comes to solve the above-described problems, as it will be further explained. The invention also aims at other objects and particularly the solution of other problems as will appear in the rest of the present description.

### SUMMARY

According to a first aspect, the invention refers to a packaged product 20 comprising a food product 24 to be cooked in a cooking device 10, the packaged product 20 comprising identification means 21 providing information to and readable by the cooking device 10 related to a plurality of steps to be applied for cooking the food product 24 according to a predetermined profile, such that, in particular the duration, the selection of the heating mode and the power level of each of the heating mode, optionally and additionally a cooling mode, are set for each one of these steps according to the type of product to be cooked. The heating mode for each step is selected amongst one or a combination of microwave heating, infrared heating, hot air convection or hot air impingement, the cooling mode being applied by one or a combination of sub-pressure cooling or air ventilation.

Preferably, the identification means 21 of the packaged product 20 also provide the cooking device 10 with information on the initial status of the food product 24 as to any one or a combination of the following information: weight, size, shape or water content. These identification means 21 are preferably arranged in any one or a combination of: a primary packaging 22 carrying the food product 24, the food product 24 or a secondary packaging 23 outside the primary packaging 22.

Typically, the food product 24 is carried in a primary packaging 22 shaped as a tray, comprising the identification means 21 on a lower side such that they can be read as the product enters the cooking device 10.

The food product 24 is preferably raw or is partially baked, and is initially chilled, frozen or shelf-stable.

The identification means 21 preferably comprise any one or a combination of: an optically readable code, such as a barcode, preferably a 2D barcode, a radio-frequency code or an inductive or conductive or electromagnetic code.

According to a preferred embodiment of the invention, the packaged product 20 is configured as a single-use packaged product 20 comprising identification means 21 configured as a single-use identification code that can be read once. In this case, the identification means 21 preferably comprise any one or a combination of: an ink reacting to heat, a varnish becoming dark with heat or a flash memory erased after being read.

According to a second aspect, the invention relates to a cooking device 10 for cooking a food product 24 from a packaged product 20 as described previously inside a cavity 12, the cooking device 10 comprising:

a reader 11 retrieving from the identification means 21 in the packaged product 20 the information related to the steps applied for cooking the food product 24,

a plurality of sensors 40 monitoring a plurality of input parameters of the said steps, and

a control unit 30 receiving the information from the reader 11 and the said input parameters from the sensors 40 and acting on the cooking device 10 to control the heating mode, optionally the cooling mode, according to the predetermined profile so to equate or approximate under a certain deviation the input parameters from the sensors 40 with the targeted values for each one of the steps carried out.

Preferably, the sensors 40 in the cooking device 10 monitor for each one of the steps one or a combination of the following parameters: time elapsed, temperature inside the cavity 12 or heating power applied from the corresponding heating means.

According to one embodiment, the reader 11 is located outside the cavity 12 arranged in such a way that the identification means 21 are read by the reader 11 as the food product 24 is introduced in the cavity 12 for being cooked. According to another embodiment, the reader 11 is located inside the cavity 12 and is arranged in such a way that the identification means 21 are read by the reader 11 once the food product 24 is placed inside the cavity 12 for being cooked.

According to a third aspect, the invention refers to a system 100 comprising a cooking device 10 as the one previously described and a packaged product 20 also as described, the system 100 being designed for adapting the plurality of steps carried out for cooking the food product 24 as a function of the information comprised in the identification means 21 of the packaged product 20.

According to a fourth aspect, the invention refers to a method for cooking a food product 24 from a packaged product 20 as described previously in a cavity 12 of a cooking device 10 as described, wherein the method is sequenced into a plurality of steps during which are selected: the duration of the step, the selection of the heating mode and its power level, optionally and additionally a cooling mode.

Preferably, the heating mode for each step of the method according to the invention is one or a combination of different heating technologies amongst: microwave heating, infrared heating, hot air convection or hot air impingement. Also preferably, the cooling mode is one or a combination of sub-pressure cooling or air ventilation.

Preferably, in the method of the invention, the identification means 21 in the packaged product 20 are read as the food product 24 enters the cavity 12 of the cooking device 10, such that the cooking device 10 is then automatically locked and runs automatically the cooking process of the food product 24.

Also according to the invention, the plurality of steps in the method described are also adapted as a function of the initial calibration of the food product 24 as to any one or a combination of its weight, size, shape or water content or as a function of the initial temperature of the food product 24.

### BRIEF DESCRIPTION OF THE DRAWINGS

Further features, advantages and objects of the present invention will become apparent for a skilled person when reading the following detailed description of non-limiting embodiments of the present invention, when taken in conjunction with the appended drawings, in which:

FIG. 1 shows a schematic view of one exemplary possible embodiment of the automated system for preparing dough-based products, according to the present invention.

FIG. 2 shows a schematic view of the automated system for preparing dough-based products in a dedicated cooking device, from a dedicated packaged product, according to the present invention.

FIG. 3 shows a schematic functional diagram of the components of the automated system for preparing dough-based products, according to the present invention.

FIG. 4 shows schematically an example of the possible process steps carried out in a baking or cooking cycle for preparing a croissant in an automated system for preparing dough-based products, according to the present invention.

FIG. 5 shows schematically an example of possible process steps carried out in a baking or cooking cycle for preparing a sandwich croque-monsieur in an automated system for preparing dough-based products, according to the present invention.

### DETAILED DESCRIPTION

The present invention is directed to a baking system 100 for preparing a plurality of dough-based products of premium quality in very short time. The baking system 100 of the invention works in a completely automatic way: the baking system 100 comprises a cooking device 10 and a dedicated packaged product 20.

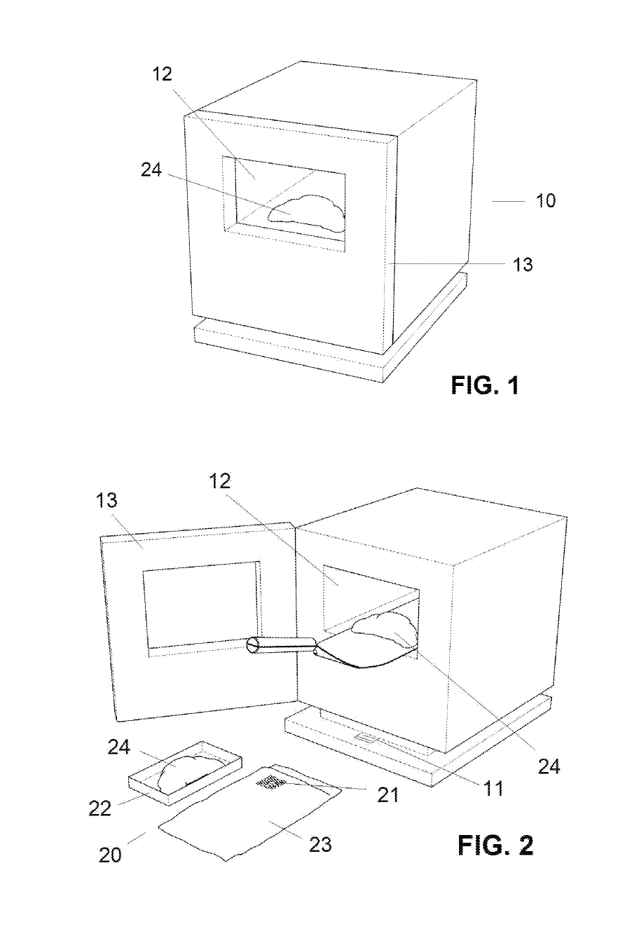

The baking system 100 of the invention adapts the baking/cooking profile of the product to be prepared inside a cooking device 10, based on the identification of the dedicated packaged product 20, to be used in the baking system 100. The packaged product 20 comprises identification means 21, typically a code. The identification means 21 can be printed on the package or embedded in its packaging structure depending on the recognition technology used. The code can be an optically-readable code such as barcode or a radio-frequency code or an inductive or conductive or electromagnetic code. It can preferably be a 2D barcode, comprising the information on the product and also on the optimum cooking profile to be applied by the cooking device 10 for cooking the product. The cooking device 10 comprises a reader 11, preferably a camera, which reads and retrieves (decodes) the information in the identification means 21 of the packaged product 20: preferably, the reader 11 is located outside the cavity 12 of the cooking device 10, so that the identification means 21 are read by the reader 11 before the packaged product 20 enters the cavity 12. More preferably, as shown in FIGS. 1 and 2, the reader 11 will be located outside the cavity 12, in a place such that the identification means 21 will be read as the user introduces the packaged product 20 in the cooking device 10 (in FIGS. 1 and 2, exemplary embodiments are shown in which the identification means 21, preferably a code, is located at the bottom of the packaged product 20, the reader 11 being located such that it confronts the code as the product enters the cavity 12). Another possibility is that the reader 11 is located inside the cavity 12 of the cooking device 10, so that the identification means 21 are read once the packaged product 20 is inside the cavity 12, ready for being cooked. Preferably upon confirmation by the user (though it can also be done in a completely automatic way), the cooking device 10 launches the cooking program: the product recipe and the technologies applied are adapted by the cooking device 10 to guarantee the best cooking result for each type of product. The baking process is fully automatic and stops automatically at the end of the baking/cooking cycle. The system is fully automatic and there are no actions needed on the part of the user to identify the product, contrary to existing systems in the state of the art. Thus, the best cooking results are further guaranteed as the heating technologies and baking/cooking profiles are managed by the system 100.

In one aspect possible, the packaged product 20 is a single-use packaged product 20 and the identification means 21 are a single-use identification code that can only be read once. Advantageously, the code is damaged or destroyed during cooking such as by heat, cooling and/or moisturizing, thus being read only once minimizing the possibility of errors in the process. For example, this can be done by using an ink (optically readable code) that reacts to heat and that blackens the code and makes it unreadable after the cooking process has taken place. Another possibility is that the code is covered with a transparent varnish that becomes dark above a set temperature, so the code is only used once. Still another solution would be that the code comprises a small flash memory in between two layers of paper, also comprising print or glue electrical connection: this would configure a flash drive with limited memory. The user would detach the code (it would be preferably precut) and would insert it in a dedicated portion of the cooking device 10: this flash drive would contain the baking recipe, and would be erased just after having been read, so the code would be only useable once.

According to another embodiment of the invention, the identification means 21 in the packaged product 20 can also be made re-usable, meaning that it can be read more than once. In this case, the control unit 30 in the cooking device 10 will preferably be programmed with the number of times the identification means 21 can be read or accepted.

Typically, a packaged product 20 would comprise a food product 24, a primary packaging 22 enveloping the product and a secondary packaging 23 outside the primary packaging 22. The secondary packaging 23 can also be used to group a plurality of primary packages together, so that in one baking/cooking cycle, a plurality of food products 24 can be prepared at the same time. The primary packaging 22 can also be used as baking tray and serving plate for the food product 24. Typically, the identification means 21 of the packaged product 20 are located in the primary packaging 22, preferably in the bottom of the primary packaging 22, typically configured as baking tray.

The identification means 21 in the packaged product 20 preferably comprise information related to any one of the following combinations, of conditions as detailed herewith, thus enhancing the final cooking results.

Number of a plurality of steps to be applied by the cooking device 10 and, for each step: type of heating technologies applied, during which time, with which power levels, together with the temperature, the humidity level and the pressure inside the cavity 12 for each of the steps and together with the desired temperature of the food product 24, for each of the steps.

Pre-heating time and pre-heating temperature, when required, of the cavity 12 before insertion of the packaged product.

Initial status of the food product 24, preferably at least one or a combination of its weight, size, shape or water content.

Packaging material of the primary packaging 22.

Preferably, the cavity 12 of the cooking device 10 is specially tailored for dough-based products such as bakery and pastry products for example, so better results can be achieved with the system 100 of the invention. Typically, the dimensions of the cavity 12 can be based on the following three requirements: (1) as small as possible to concentrate all the heating power on the food product 24, (2) easy to use, i.e. it should be easy to put in and extract the products and to clean, and (3) the relative humidity during baking (taking into account the humidity evacuation with the air ventilation) should be reasonably low to allow fast browning of the food product 24.

The system of the invention operates the cooking device 10 according to the information comprised in the identification means 21 of the packaged product 20, following a plurality of steps, such that the heating technologies used in each step can be one or a combination of the following.

Microwave heating for heating the core of the product, generated by a magnetron with a maximum power preferably comprised in the range from 100 to 4000 W, more preferably of from 800 to 1500, most preferably 1000 W, also using one or more rotating wave stirrers reflecting microwave energy to parts of the cavity 12 as they rotate, or a turntable (carousel) which turns the food product 24, or both.

Infrared lamps, preferably halogen broadband infrared lamps are used for surface heating of the food product 24, particularly to boost browning of the product and to reduce the total cooking time: preferably, these infrared lamps will deliver in total a maximum power of 2000 W.

Hot air convection for surface browning providing a good homogeneity in the product, which can be used with all kind of products (not only homogenous or flat ones).

Moreover, the air temperature is preferably limited to around 240° C., which allows the use of more conventional and standard packaging materials for the primary packaging 22. Optionally, but preferably, and also according to the invention, hot air impingement can be used for surface browning: both heating technologies, hot air convection or hot air impingement need preheating of the cavity 12, hot air impingement being faster than hot air convection.

The system of the invention operates the cooking device 10 to regulate the temperature inside the cavity 12, by using the following techniques, indicated herewith.

Air ventilation inside the cavity 12, preferably by using a single ventilator, to cool down the electronics and the magnetron, and to introduce air in the cavity 12 preferably through the infrared lamps so that the air is heated and humidity is therefore evacuated from the cavity 12, which is important for obtaining a good browning of the food product 24.

Sub-pressure cooling is typically applied while microwave heating is acting, which allows that the food product 24 maintains its shape while being cooked or baked in the cooking device 10. The sub-pressure cooling dries out the exterior of the food product 24 during the core heating phase with microwaves for example, so that the food product 24 continues increasing in volume and/or maintaining its volume despite the lack of crust (there is not crust when baking is done using microwaves, for example).

The baking system 100 of the invention regulates the temperature of the packaged product by applying simultaneously one or a combination of the heating technologies described above, together with air ventilation or sub-pressure cooling. By sub-pressure it shall be understood the lowering and maintaining of the pressure inside the cavity 12 of the cooking device 10 below the atmospheric pressure.

It is to be noted that the baking system 100 of the invention uses hot air convection and/or hot air impingement as source of surface heating: as already disclosed, pre-heating is needed for these techniques, but by using also infrared lamps, preferably halogen broadband infrared lamps, the surface heating of the product is boosted and the total amount of baking time is minimized.

The cooking device 10 of the invention also comprises a control unit 30 which receives the information retrieved by the reader 11 from the identification means 21 in the packaged product 20. The cooking device 10 also comprises a plurality of sensors 40, monitoring a plurality of parameters of the baking/cooking process: the parameter values measured by the plurality of sensors 40 are transmitted to the control unit 30, during the cooking or baking process. The control unit 30 is thus provided with information from the reader 11, which comes from the identification means 21, providing the values desired (targeted) for the process parameters, and is also provided with the information coming from the sensors 40, providing the real measured values of the different process parameters: the control unit 30 compares both information and adjusts the process parameters by acting on the cooking device 10, to achieve that the real measured values are equal or approximate to the targeted ones under a certain allowed deviation, depending on the calibration of the cooking device 10. The control unit 30 runs and monitors the process in a continuous manner, throughout the cooking or baking process.

The sensors 40 provide the control unit 30 with any one of the following information, as will be detailed hereunder.

Time elapsed

Temperature inside the cavity 12

Heating power applied by the corresponding heating means

Optionally, the sensors 40 can also provide the control unit 30 with any one of the following information, detailed herewith.

Humidity level inside the cavity 12

Pressure inside the cavity 12 (measured by a dedicated sensor 43)

Temperature of the food product 24

The initial departing temperature of the food product 24 is also of particular importance for the cooking or baking process in the system, having a significant impact on the end product. For this reason, the corresponding sensor measuring the product temperature will carry out this initial measurement which will be sent to the control unit 30 for proper calibration of the cooking device 10 before the start of the process. Also, the initial status of the food product 24 is of particular importance: variations in product size, shape, weight or water content, for example, will influence the determination of the baking profile such as by amending the target values and/or the output responses, for example.

The cooking device 10 of the invention can further comprise sensors dedicated to any one of the following operations:

An interlock switch 41 detecting the status of the door 13 of the cooking device 10, indicating the control unit 30 that the door 13 is either locked or unlocked: typically, the interlock switch 41 comprises three check-points which are controlled to provide a further security check and monitor that the door 13 is either locked or unlocked. According to the invention, the system automatically acts on locking and unlocking the door 13, so as to prevent any risks or possible accidents. Therefore, for example, the door 13 is locked and remains locked as soon as the baking or cooking process has started. The door 13 is only unlocked when the process has come to an end and there is no risk for the user to open it and to access the cavity 12 to get the food product 24.

A start/stop sensor 42 connected to a start/stop button (not shown) receiving manual inputs from the user: these inputs can come, for example, at the beginning of the process, so that it is the user who commands the start of the cooking or baking process in the cooking device 10, or can receive a stop command from the user while the cooking or baking process is taking place in the cooking device 10; in this last case, input from the user can come from emergency situations, for example, in case the user wants to stop the cooking or baking process abruptly by pressing the start/stop button, so that the sensor 42 will communicate this input to the control unit 30. The control unit 30 will then check the process parameters by reading the plurality of sensors 40, and will either unlock the door 13 or will keep it locked and will act on the cooking device 10 until the conditions inside the cavity 12 are safe to allow the user to open the door 13.

A pressure sensor 43 monitoring the sub-pressure cooling level within the cavity 12 (in fact, it monitors the pressure inside the cavity 12) in the cooking device 10 is also connected to the control unit 30.

The materials configuring the primary packaging 22 of the packaged product 20 in the baking system 100 of the invention must fulfil several conditions: (1) withstand the heat radiation without losing structural integrity, (2) be considered food safe both before and after the processing, and (3) be compatible for use with microwave heating. Taking into consideration these conditions, the preferred packaging materials for the primary packaging 22 are glass, ceramics, fiberglass mesh coated with polytetrafluoroethylene (PTFE), variations of parchment paper or combination of PTFE mesh coated with parchment paper, cardboard, paper, cardboard or paper coated with PE or PET, silicon, etc. It is to be noted that this list of packaging materials for the primary packaging 22 is not exhaustive. The primary packaging 22 can be used as baking tray and serving plate, preferably made of PTFE coated fiberglass mesh or of a combination of PTFE mesh and parchment paper. Preferably, the identification means 21 of the packaged product 20 will be located in the primary packaging 22.

The dough-based products 24 packed in the packaged product 20 can be raw foods or will preferably be partially baked: in any case, they can be chilled, frozen, or shelf stable. In case they are frozen, a significant amount of energy in the cooking or baking process will be dedicated to overcome the frozen-chilled barrier. Typically, chilled products are designed to be stored for a determined number of days at temperature between 4° C. and 6° C., frozen products at temperature below 0° C., preferably between −2° C. and −20° C., and shelf stable products at ambient temperature. Also according to the invention, the dough-based products 24 in the packaged product 20 can be raw materials, which will be later cooked in the cooking device 10. It is also possible according to the invention to provide a packaged product 20 having different zoning, preferably by providing different areas in the food product 24 that will be baked in a different way (i.e., under different cooking profiles) depending on the configuration of these zoning areas. Typically, this will be provided as different coatings in the food product 24 which will provide different time, temperature and direction and type of heating over the zoning of the food product 24.

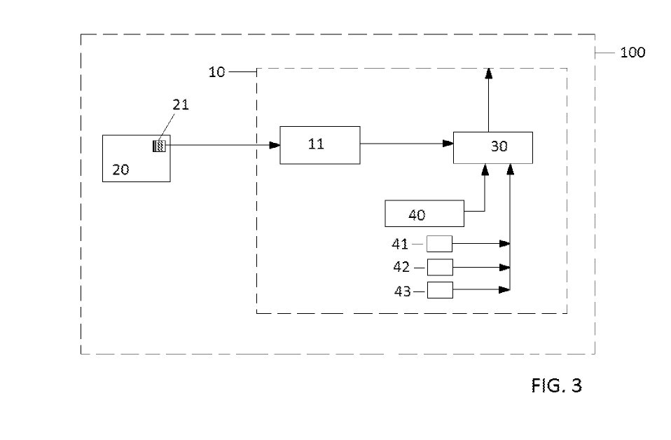

Also, the present invention is directed to a method for preparing a plurality of dough-based products in an automated baking system 100, departing from a packaged product 20 and using a cooking device 10. The functional diagram showing the functionalities of the system of the invention and its operational method is schematically exemplarized in FIG. 3.

First, the user takes one packaged product 20, which can be chilled, frozen, or shelf stable (ambient temperature): typically, the packaged product 20 comprises a primary packaging 22 and a secondary packaging 23. Therefore, as shown in FIG. 2, the user first opens the secondary packaging 23, typically designed for easy handling and opening.

Once the secondary packaging 23 has been opened, the primary packaging 22, typically configured as a baking tray, holding the food product 24 on it, is directly and easily accessible to the user through the opening in the secondary packaging 23 (for example if it is a flow pack as shown in FIG. 2). The identification means 21 will preferably comprise a code, which will be preferably printed on the bottom of the primary packaging 22 (baking tray) and is easily read by the reader 11 in the cooking device 10 once the user approaches the cooking device 10. Another possibility is that the reader 11 is arranged inside the cavity 12 of the cooking device 10, so the code will then be read once the primary packaging 22 is inside the mentioned cavity 12 (typically, the reader 11 is located inside the cavity 12 arranged in such a way that the code is confronted to the reader 11 once the food product 24 is placed inside the cavity 12 for being cooked, typically in the primary packaging 22). The code comprises the baking profile (steps, combination of heating technologies, power levels, timings, etc.) necessary to bake and deliver the best possible end-result food product 24. According to another preferred embodiment of the invention, the code can also be located in the secondary packaging 23, and will be read by the reader 11 in a similar way as that explained.

Then, the user places the food product 24 on its baking tray (primary packaging 22), inside the cavity 12 of the cooking device 10. The baking/cooking process can start either automatically, or once the user presses the dedicated start/stop button, but always once the control unit 30 has checked the interlock switch 41 and has confirmed that the door 13 is properly locked. Once this is done, the door 13 remains locked during the complete baking cycle.

The information comprised in the identification means 21 is read and decoded by the reader 11, this information being then transmitted to the control unit 30. Typically, the information transmitted to the control unit 30 is the following: steps to be applied by the cooking device 10 and, for each step, type and combination of heating technologies applied, during which time and with which power level; temperature, humidity level and pressure inside the cavity 12 and temperature of the food product 24; pre-heating time and pre-heating temperature of the cavity 12, if any; initial status of the food product 24, preferably at least one or a combination of weight, size, shape or water content; packaging material of the primary packaging 22.

The control unit 30 compares the information and targeted values comprised in the identification means 21 transmitted by the reader 11, with the real measured values coming from the plurality of dedicated sensors 40, typically: time elapsed, temperature, humidity level and pressure inside the cavity 12, heating power applied by the corresponding heating means, temperature of the food product 24 and initial status of the food product 24, preferably as to at least one or a combination of weight, shape, size or water content. Also, the control unit 30 receives the following measured information in real time: the status of the cooking device door 13 provided by the interlock switch 41, any manual input entered by the user provided by the start/stop sensor 42 and optionally the pressure inside the cavity 12 provided by the pressure sensor 43.

The control unit 30 then acts on the cooking device 10, to achieve that the real measured values coming from the sensors 40, and the targeted ones coming from the identification means 21 are equal or approximate under a certain allowed deviation, this deviation depending on the calibration of the cooking device 10. The control unit 30 runs and monitors the process as detailed above in a continuous manner, throughout the complete cooking or baking process.

At the end of the baking or cooking cycle, the door 13 unlocks automatically so that the user can open it. The user can then see that the food product 24 is ready and can then proceed to take it out of the cavity 12. The baking tray (primary packaging 22) can also be used as a serving tray.

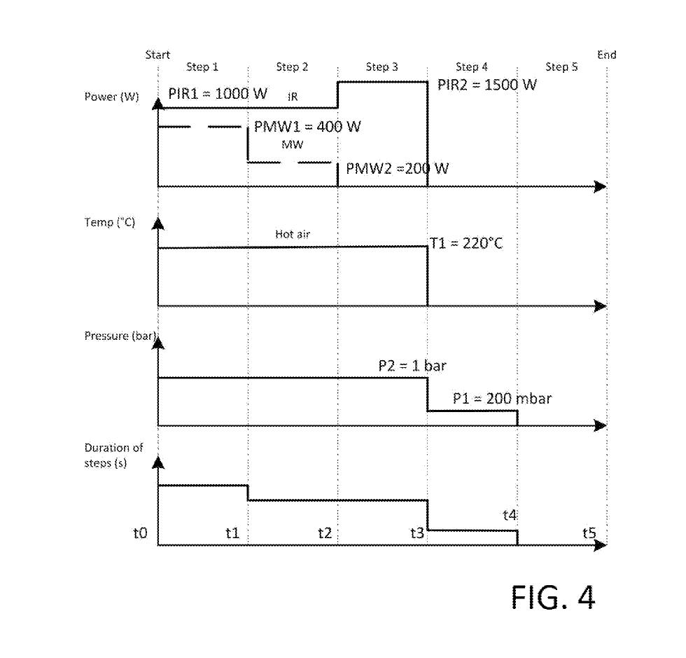

An exemplary baking or cooking cycle into five steps carried out by the baking system 100 of the invention for preparing a croissant is shown in FIG. 4.

In Step 1, taking place from t₀ to t₁, microwave heating at a power level of P_{MW1} is applied for core heating of the croissant product. At the same time, hot air impingement at a temperature of T₁ is also applied for the browning of the product and crust formation. Simultaneously in Step 1, halogen broadband infrared heating with power level of P_{IR1} is also applied, in order to boost the browning process and to reduce the total baking time. In Step 1, the pressure inside the cavity 12 is maintained at P₂, typically ambient pressure of 1 bar, no cooling taking place at this stage.

In Step 2, taking place from t₁ to t₂, microwave heating is applied for core heating of the croissant product, but at a much lower power level of P_{MW2}. At the same time, hot air impingement at a temperature of T₁ is also applied for the browning of the product. Simultaneously in Step 2, halogen broadband infrared heating with power level of P_{IR1} is also applied, again to boost the browning process and to reduce the total baking time. In Step 2, the pressure inside the cavity 12 is still maintained at P₂, typically ambient pressure of 1 bar, no cooling taking place at this stage.

Then, Step 3 takes place from t₂ to t₃, where the browning of the product occurs, by applying halogen broadband infrared heating with a high power level of P_{IR2} together with hot air impingement at a temperature of T₁. The pressure inside the cavity 12 is maintained at P₂, typically ambient pressure of 1 bar, no cooling taking place at this stage.

Step 4 is applied later on, from t₃ to t₄, where cooling of the product takes place by sub-pressure cooling such that the pressure inside the cavity 12 is lowered and maintained at P₁ until the product is cooled down.

Finally, Step 5 takes place from t₄ to t₅, where no heating or cooling technology is applied: the purpose of this step is to cool down by time the product and to stabilize it for its final consumption. At the end of the process, the dedicated sensor 40 measuring the temperature of the food product 24 checks that this temperature is correct, so the control unit 30 commands the interlock switch 41 to unlock the door 13 so it can be opened to extract the cooked product.

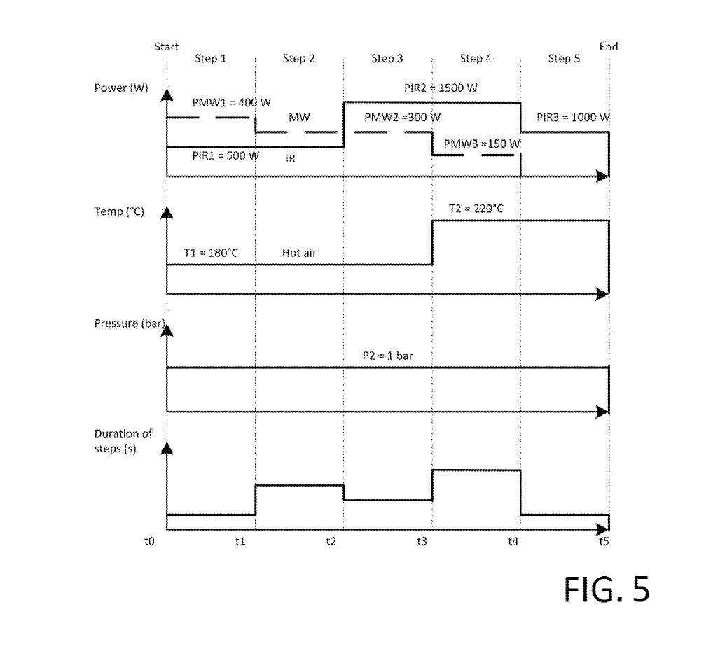

An exemplary baking or cooking cycle into five steps carried out by the baking system 100 of the invention for preparing a sandwich croque-monsieur is shown in FIG. 5.

In Step 1, taking place from t₀ to t₁, microwave heating at a power level of P_{MW1} is applied for core heating of the croque-monsieur product: the croque-monsieur product is typically introduced frozen so, basically, between t₀ to t₁ the main target is the defrosting of the product, so therefore high microwave heating power level is applied together with low air temperature. In fact, slow heating of the exterior of the product takes place, so that grilling of the cheese on the surface of the croque monsieur can take place in subsequent steps. At the same time, hot air impingement at a temperature of T₁ is also applied for the browning of the product. Simultaneously in Step 1, halogen broadband infrared heating with power level of P_{IR1} is also applied, in order to boost the browning process and to reduce the total baking time. In Step 1, the pressure inside the cavity 12 is maintained at P_{2,} typically ambient pressure of 1 bar (in the case of croque monsieur exemplified, melted cheese does not react well to sub-pressure).

In Step 2, taking place from t₁ to t₂, microwave heating is applied for core heating of the croque-monsieur product, at a lower power level of P_{MW2}. At the same time, hot air impingement at a temperature of T₁ is also applied for the browning of the product. Simultaneously in Step 2, halogen broadband infrared heating with the same power level of P_{IR1} is also applied, again to boost the browning process and to reduce the total baking time. In Step 2, the pressure inside the cavity 12 is still maintained at P_{2,} typically ambient pressure of 1 bar, no cooling taking place at this stage.

Then, Step 3 takes place from t₂ to t₃, where the core heating and the browning of the product occurs, by simultaneously applying halogen broadband infrared heating with a high power level of P_{IR2} together with halogen broadband infrared heating with a power level of P_{IR2} and with hot air impingement at a temperature of T₁. The pressure inside the cavity 12 is maintained at P₂, typically ambient pressure of 1 bar. No cooling takes place in this Step 3, as it is the grilling of the cheese in the croque monsieur what is pursued now.

Further, Step 4 occurs from t₃ to t₄, where the browning of the product occurs, by applying halogen broadband infrared heating with power level of P_{IR2} together with hot air impingement at a higher temperature of T₂. At the same time, as the croque-monsieur product requires longer cooking of the inside part, core heating is still maintained but at a lower power level of P_{MW3}. The pressure inside the cavity 12 is still maintained at P₂, typically ambient pressure of 1 bar. Again, no cooling is taking place in this Step 4, being the grilling of the cheese what is intended.

Finally, Step 5 is applied from t₄ to t₅, where final browning of the product takes place by the application of halogen broadband infrared heating with a power level of P_{IR3} together with high hot air impingement at a temperature of T₂. Cooling of the product takes place by sub-pressure cooling, the pressure inside the cavity 12 is still maintained at P₂ (1 bar, ambient pressure) until the product is cooled down. Once the process has ended, the control unit 30 commands the interlock switch 41 to unlock the door 13 so it can be opened to extract the cooked product.

The baking system 100 of the invention is compact and is able to achieve very low variation in results between first and subsequent baking cycles. As a way of example, for initial temperature of the food product 24 of about −18° C. (frozen), a croissant of initial weight 40 g will be ready in about 70 seconds, and a croquet-monsieur departing at about −18° C. (frozen), will need about 180 seconds.

Although the present invention has been described with reference to preferred embodiments thereof, many modifications and alternations may be made by a person having ordinary skill in the art without departing from the scope of this invention which is defined by the appended claims.

1. Packaged product comprising a food product to be cooked in a cooking device, the packaged product comprising an identification member providing information to and readable by the cooking device related to a plurality of steps to be applied for cooking the food product according to a predetermined profile, such that, the duration, the selection of the heating mode and the power level of each of the heating mode, are set for each one of these steps according to the type of product to be cooked.

2. Packaged product according to claim 1, wherein the heating mode for each step is selected from the group consisting of microwave heating, infrared heating, hot air convection and hot air impingement.

3. Packaged product according to claim 1, wherein the cooling mode is applied by one or a combination of sub-pressure cooling or air ventilation.

4. Packaged product according to claim 1, wherein the identification member also provides the cooking device with information on the initial status of the food product.

5. Packaged product according to claim 1, wherein the identification member is arranged in a manner selected from the group consisting of: a primary packaging carrying the food product; the food product; and a secondary packaging outside the primary packaging.

6. Packaged product according to claim 1, wherein the food product is carried in a primary packaging shaped as a tray, comprising the identification member on a lower side such that they can be read as the product enters the cooking device.

7. Packaged product according to claim 1, wherein the food product is in a state selected from the group consisting of raw, is partially baked, is chilled, frozen and shelf-stable.

8. Packaged product according to claim 1, wherein the identification member is selected from the group consisting of: an optically readable code, a radio-frequency code, and an inductive or conductive or electromagnetic code.

9. Packaged product according to claim 1 configured as a single-use packaged product comprising identification member configured as a single-use identification code that can be read once.

10. Packaged-product according to claim 9, wherein the identification member is selected from the group consisting of: an ink reacting to heat, a varnish becoming dark with heat and a flash memory erased after being read.

11. A cooking device for cooking a food product from a packaged product comprising:
a reader retrieving from an identification member in the packaged product the information related to the steps applied for cooking the food product;
a plurality of sensors monitoring a plurality of input parameters of the steps; and
a control unit receiving the information from the reader and the input parameters from the sensors and acting on the cooking device to control the heating mode, according to the predetermined profile so to equate or approximate under a certain deviation the input parameters from the sensors with the targeted values for each one of the steps carried out.

12. A cooking device according to claim 11, wherein the sensors monitor for each one of the steps a parameter selected from the group consisting of: time elapsed, temperature inside the cavity and heating power applied from a corresponding heating member.

13. A cooking device according to claim 11, wherein the reader is located outside the cavity arranged in such a way that the identification member is read by the reader as the food product is introduced in the cavity for being cooked.

14. A cooking device according to claim 11, wherein the reader is located inside the cavity arranged in such a way that the identification member is read by the reader once the food product is placed inside the cavity for being cooked.

15. A system comprising a cooking device according to claim 11, and a packaged product comprising a food product to be cooked in a cooking device, the packaged product comprising an identification member providing information to and readable by the cooking device related to a plurality of steps to be applied for cooking the food product according to a predetermined profile, such that, the duration, the selection of the heating mode and the power level of each of the heating mode, are set for each one of these steps according to the type of product to be cooked, the system being designed for adapting the plurality of steps carried out for cooking the food product as a function of the information comprised in the identification member of the packaged product.

16. Method for cooking a food product from a packaged product comprising a food product to be cooked in a cooking device, the packaged product comprising an identification member providing information to and readable by the cooking device related to a plurality of steps to be applied for cooking the food product according to a predetermined profile, such that, the duration, the selection of the heating mode and the power level of each of the heating mode, are set for each one of these steps according to the type of product to be cooked in a cavity of a cooking device, wherein the method is sequenced into a plurality of steps during which are selected from the group consisting of: the duration of the step, the selection of the heating mode, its power level, and a cooling mode.

17. Method according to claim 16, wherein the heating mode for each step is a heating technology selected from the group consisting of: microwave heating, infrared heating, hot air convection and hot air impingement.

18. Method according to claim 16, wherein the cooling mode is one or a combination of sub-pressure cooling or air ventilation.

19. Method according to claim 16, wherein the identification member in the packaged product is read as the food product enters the cavity of the cooking device, such that the cooking device is then automatically locked and runs automatically the cooking process of the food product.

20. Method according to claim 16, wherein the plurality of steps are also adapted as a function of the initial calibration of the food product as to any one or a combination of its weight, size, shape or water content or as a function of the initial temperature of the food product.
